(19) United States
(12) Patent Application Publication
(10) Pub. No.: US 2011/0123067 A1
(43) Pub. Date: May 26, 2011

(54) Method And System for Tracking a Target

(75) Inventor: Christine Podilchuk, Warren, NJ (US)

(73) Assignee: D & S CONSULTANTS, INC., Eatontown, NJ (US)

(21) Appl. No.: 13/017,293

(22) Filed: Jan. 31, 2011

Related U.S. Application Data
(63) Continuation-in-part of application No. 11/619,083, filed on Jan. 2, 2007.
(60) Provisional application No. 60/812,616, filed on Jun. 12, 2006.
(60) Provisional application No. 60/816,686, filed on Jun. 27, 2006.
(60) Provisional application No. 60/861,685, filed on Nov. 29, 2006.
(60) Provisional application No. 60/861,932, filed on Nov. 30, 2006.
(60) Provisional application No. 60/873,179, filed on Dec. 6, 2006.
(60) Provisional application No. 60/814,611, filed on Jun. 16, 2006.

(51) Int. Cl. G06K 9/00

(52) U.S. Cl. 382/103

(57) ABSTRACT

A method and system for tracking one or more targets is described. The method includes the step of selecting a first template having a first image of a target and cyclically repeated steps of accumulating new images of the target, producing updated templates containing the new images, and tracking the target using the updated templates. Embodiments of the method use techniques directed to detection and mitigation of target occlusion events.

### CROSS-REFERENCE TO RELATED APPLICATIONS

This application is a continuation-in-part of U.S. patent application Ser. No. 11/619,083, filed Jan. 2, 2007, which claims benefit of U.S. provisional patent application 60/814,611, filed Jun. 16, 2006, entitled “Target Tracking Using Adaptive Target Updates and Occlusion Detection and Recovery”, which is incorporated herein by reference.

### FIELD OF THE INVENTION

The present inventions generally relates to the field of electronic surveillance and, in particular, to a method and system for tracking targets.

### BACKGROUND OF THE INVENTION

Target tracking is used by military, law enforcement, commercial, and private entities. The goal of target tracking is recognition and then monitoring of one or more objects of interest (referred to herein as “targets”) in video data sequences produced by respective surveillance apparatus(es). In applications, target tracking is performed in real time or, alternatively, using pre-recorded surveillance data.

Main challenges in the field of target tracking relate to identification of targets that change their appearance due to motion, orientation in 3D space, or temporary occlusion by other objects. Despite the considerable effort in the art devoted to methods and systems for tracking targets, further improvements would be desirable.

### SUMMARY OF THE INVENTION

One aspect of the invention provides a method for tracking one or more targets. The method includes the step of selecting a first template having a first image of a target and a plurality of cyclically repeated steps of accumulating current images of the target, producing updated templates, and tracking the target using the updated templates. In one embodiment, the updated template is generated if the target is recognized using the first or previously updated template; otherwise these templates are adopted as the updated templates. In further embodiments, the method uses techniques directed to recovery from tracking failures and mitigation of target occlusion events.

Another aspect of the present invention provides a system using the inventive method for tracking one or more targets.

Various other aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a flow diagram illustrating a method for tracking at least one target in accordance with one embodiment of the present invention.

FIG. 2 is a high-level, schematic diagram of an exemplary system using the method of FIG. 1.

To facilitate understanding, identical reference numerals have been used, where possible, to designate identical elements that are common to the figures. The images in the drawings are simplified for illustrative purposes and are not depicted to scale.

The appended drawings illustrate exemplary embodiments of the invention and, as such, should not be considered as limiting the scope of the invention that may admit to other equally effective embodiments. It is contemplated that features or steps of one embodiment may beneficially be incorporated in other embodiments without further recitation.

### DETAILED DESCRIPTION

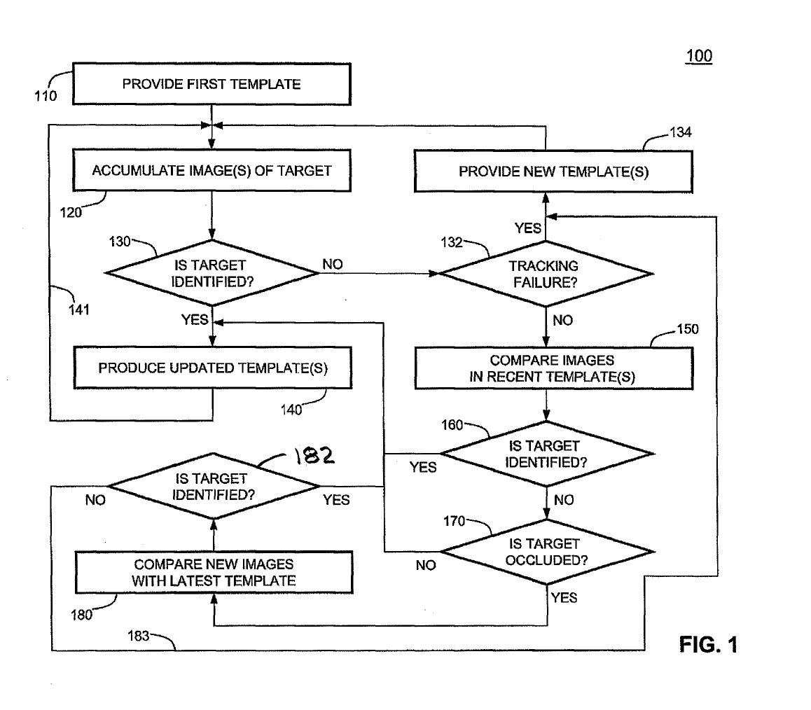

Referring to the figures, FIG. 1 depicts a flow diagram illustrating a method 100 for tracking at least one target in accordance with one embodiment of the present invention.

Hereafter, aspects of the present invention are illustratively described within the context of live targets (for example, humans, animals, or body parts thereof) or material objects, which movements are monitored in the respective conventional habitats, conditions, or environment.

The invention may also be utilized within the context of other types of targets, such as missiles or their plumes (for example, reactive propelled grenades (RPGs), ballistic or cruise missiles, among other missiles), beams of laser light, objects floating in air, free space, in liquid or on a surface of liquid, and the like. It has been contemplated and is within the scope of the invention that the method 100 is utilized within the context of such targets.

In various embodiments, method steps of the method 100 are performed in the depicted order or at least two of these steps or portions thereof may be performed contemporaneously, in parallel, or in a different order. For example, portions of steps 120 and 130 may be performed contemporaneously or in parallel. Those skilled in the art will readily appreciate that the order of executing at least a portion of other discussed below processes or routines may also be modified.

In application, a plurality of targets may similarly be tracked using processing steps of the method 100 that is illustratively discussed below in reference to a single target.

A template, for purposes of this application, is a rectangular portion of an image which contains the target or object of interest, with minimal background. Preferably, the rectangle should be just large enough to contain the target. A template is defined by an (X,Y) coordinate defining a location within the larger image and the width and height of the rectangle.

At step 110, an initial, or first, template having an image of a target is provided or generated. The initial template is generally taken from a single frame of a video that contains, in a pre-determined digital electronic format, the image of the target operating or disposed in a particular environment. Images of the target from which a template may be generated may also be available in the form of a photograph, a picture, a sketch, or similar target-containing imagery, which are digitized (for example, scanned) and converted into a pre-determined electronic format. Additionally, it is possible to allow a user to select the target to track from a frame of the video. In this case, the initial template is created based on the user's selection, which can be made by pointing a mouse at the object of interest and clicking, by drawing a box around the object of interest, or by any other known method of selecting a graphical object from a larger image.

At step 120, a respective surveillance monitor (for example, digital video camera) starts accumulating, at a pre-determined sampling rate, images of a monitored region where the target may appear or be present. Ideally, the frame sampling rate may depend on the speed of the target, but the sampling rate may also be fixed. A typical sampling rate for standard video may be 30 frames per second. When the surveillance monitor provides output information in an analog form, such information is subsequently digitized. In one embodiment, accumulated images are converted in the pre-determined digital electronic format used in the initial template or, alternatively, the pre-determined digital electronic format is an electronic format used in the surveillance monitor.

At step 130, the method 100 queries if the target is identified in a particular accumulated image by comparing the template with the image. The target may be identified by comparing the template with various areas of the accumulated image, using well-known pattern recognition algorithms and neural network technology. The algorithm used may be dependent on the type of target, for example, a template containing a missile as the object of interest may use a different algorithm for identifying the target in the image than a template containing a face.

If the query of step 130 is affirmatively answered, the method 100 proceeds to step 140, where the portion of the accumulated image containing the identified target is adopted as an updated template, which replaces the current template of step 110. The initial template, as well as subsequent templates used to identify the object of interest may be saved as historical references.

Steps 120, 130, and 140 are cyclically repeated (shown with a link 141) and, in each cycle, a preceding template is updated with the template having an image of the target that, during a surveillance process, is constantly updated, typically on a frame-by-frame basis. Updating on a frame-by-frame basis will allow minimum change in the aspect of the target between instances of identifying the target by comparison to the current template. Such constant updates allow the tracking of targets in images which are changing over time and, as such, will increase the probability of recognizing the targets. In real-time surveillance applications, a rate of accumulating new images (i.e., sampling rate) and a rate of updating the templates should be sufficiently high to monitor changes in appearance of moving or evolving targets.

Previously used, or historic, templates are selectively saved and may be used to mitigate tracking failures, as discussed below in reference to steps 132, 170, and 182. To reduce tracking errors, during step 130, the current frame containing the target may be compared to the current template as well as to one or more templates produced during the preceding cycles (i.e., historic templates)

If the query of step 130 is negatively answered, the method 100 proceeds to step 132, where the method 100 queries if there is a tracking failure. A tracking failure may be identified if the object of interest is unable to be identified in a pre-determined number of consecutive frames. The number of frames may be dependent on the type of target, the application, the frame rate or any one of a number of other factors.

If the query of step 132 is affirmatively answered, the method 100 proceeds to step 134, where one or more new templates containing other available images of the target, are provided. Historic templates may be used for this purpose. In some embodiments, the new and initial templates may be used together to analyze images accumulated during previous or consequent steps 120.

If the query of step 132 is negatively answered, the method 100 proceeds to step 150. At step 150, to increase probability of target recognition, in addition to a latest image of the monitored region, other recent images of the region are compared with one or more recently updated or historic templates.

At step 160, the method 100 queries if the target is identified in at least one of the latest or recent images of the monitored region. If the query of step 160 is affirmatively answered, the method 100 proceeds to step 140, where the template that was used to identify the target during step 150, is adopted as the updated template. The affirmative answer to the query of step 160 indicates that the method 100 has recovered from a temporary loss of the target, thus avoiding a tracking failure.

If the query of step 160 is negatively answered, the method 100 proceeds to step 170, where the method queries if, in the monitored region, the target has become occluded or partially occluded. To determine if an occlusion or partial occlusion has occurred, the template is matched against the area of the image containing the target or the area of the image where the target is presumed to be and is compared on a pixel-by-pixel basis with the image. For each pixel, it is determined if the difference between the pixel in the template and its corresponding pixel in the image exceeds a pre-determined threshold T. The pixels may be compared using any one of many well-known methods, for example, difference or difference-squared methods. If the pixels differ by more than threshold T, then they are counted as pixels having matching errors.

Typically, threshold T is in the range of 0.2-0.3. Lower values of T produce more sensitivity in the matching process, while larger values produce a less sensitive result. If, over the entire template, a predetermined number of pixels have a matching error over threshold T, then an occlusion is declared. Typically, when 40%-60% of the pixels exhibit a matching error over threshold T, then it is determined that the target is occluded. Generally, a smaller number of pixels having matching errors are indicative of motion of the target or re-orientation or the target, rather than occlusion, whereas a large number of matching errors is indicative of an occlusion of the target. Additionally, a higher tolerance for error (a higher percentage of matching errors being tolerated) corresponds to a greater delay in detection of the occlusion event or the probability of using a faulty (i.e., outdated) template.

If the query of step 170 is affirmatively answered (i.e., occlusion of the target has been detected), the method 100 proceeds to step 180, where new accumulated images of the monitored region are compared, during a pre-determined time interval, with the latest updated template.

At step 182, the method 100 queries if, during step 180, the target is identified. If the query of step 182 is affirmatively answered, the method 100 proceeds to step 140, where the template used to identify the target is re-instated as the updated template.

If the query of step 182 is negatively answered, the method 100 proceeds to step 134 (shown with a link 183). In one embodiment, new accumulated images are compared with all available prior templates until the target is recognized. Alternatively, if the target is not recognized during a specific time interval, target monitoring may be terminated.

In exemplary embodiments, the method 100 may be implemented in hardware, software, firmware, or any combination thereof in a form of a computer program product comprising computer-executable instructions. When implemented in software, the computer program product may be stored on or transmitted using a computer-readable medium adapted for storing the instructions or transferring the computer program product from one computer to another.

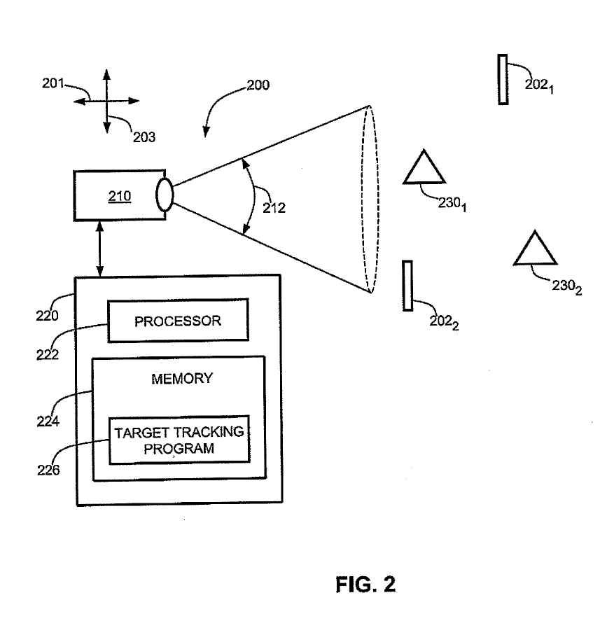

FIG. 2 is a high-level, schematic diagram of an exemplary system 200 using the method 100. To best understand the invention, the reader is suggested to refer to FIGS. 1.-2 simultaneously.

The system 200 illustratively includes at least one surveillance monitor 210 (one surveillance monitor is shown), and an analyzer 220 of data provided by the monitor 210. In one exemplary embodiment, the surveillance monitor 210 is a digital video-recording device, and the analyzer 220 is a computer having a processor 222 and a memory 224.

The memory 224 contains a target-tracking software, or program, 226 encoding, in a form of computer instructions, the method 100. When executed by the processor 222, the program 226 executes processing steps of the method 100. In some embodiments, the analyzer 220 is disposed remotely from the surveillance monitor(s) 210. Alternatively, the analyzer 220 may be a portion of the surveillance monitor.

The surveillance monitor 210 has a 3D viewing field 212 that determines boundaries of a monitored region of the system 200. To increase the monitored region, or to keep the target within the monitored area, surveillance monitor 210 or the viewing field 212 may be rotated, or scanned, about horizontal and vertical axes 201, 203. Typically, surveillance monitor 210 produces images, or frames, of the monitored region at a rate of about 10 to 100 images per second.

In the depicted embodiment, a plurality of exemplary targets 230 and objects 202 are disposed in the viewing field 212 of the surveillance monitor 210 (targets 230₁, 230₂ and objects 202₁, 202₂ are shown). Both the targets 230 and objects 202 may move in 3D space and, occasionally, the objects 202 may occlude, partially or entirely, one or more targets 230 or some targets may occlude other targets.

Although the invention herein has been described with reference to particular illustrative embodiments, it is to be understood that these embodiments are merely illustrative of the principles and applications of the present invention. Therefore numerous modifications may be made to the illustrative embodiments and other arrangements may be devised without departing from the spirit and scope of the present invention, which is defined by the appended claims.

I claim:

1. A system for tracking a target in a monitored area, comprising:
at least one sensor for collecting a sequence of images of said monitored area; and
a computer, coupled to said sensor and receiving image data therefrom, said computer running software implementing a method having the steps of:
(a) obtaining an initial template containing an image of the target to use as a current template;
(b) identifying the target in a current image of said sequence of images, by matching said current template to an area of said current image;
(c) if said target is successfully identified in said current image, forming an updated template, said updated template being the area of said current image in which said target was identified which includes the target and minimal background; and
(d) using said updated template as the current template with the next image in said sequence of images.

2. The system of claim 1 where said template is a rectangular image minimally sized to contain only an image of said target with minimal background imagery.

3. The system of claim 1, wherein said method implemented by said software further includes the step of cyclically repeating the steps (b)-(d).

4. The system of claim 1 further including the step of using said current template as the updated template for the next image in the sequence of images if said target is not identified in said current image.

5. The system of claim 2, wherein step (c) further includes storing the current template as a historic template known to contain said target.

6. The system of claim 5 further including the step of, 14. The system of claim 1, wherein said computer is disposed remotely from said at least one sensor. if said target is not identified in a pre-determined number of sequential images, using one or more of said historic templates to identify said target in said current image and in subsequent images in said sequence of images.

7. The system of claim 6, further including the step of detecting an occlusion of the target if a predetermined percentage of the pixels in the current template have matching errors greater than a predetermined threshold when compared with corresponding pixels in the current image.

8. The system of claim 7, wherein the predetermined threshold is selected in a range of about 0.2-0.3.

9. The system of claim 7 wherein the predetermined percentage is selected in a range of about 40%-60%

10. The system of claim 1, wherein said software selectively tracks multiple targets in said sequence of images.

12. The system of claim 1, wherein said at least one sensor comprises a video device.

13. The system of claim 1, wherein said computer comprises a memory containing the instructions and a processor executing the instructions.

14. The system of claim 1, wherein said computer is disposed remotely from said at least one sensor.

15. The system of claim 1, wherein said computer is a portion of said at least one sensor.

16. The system of claim 1 wherein said sensor may be moved to keep the target within the monitored area.

17. The system of claim 1 wherein the template is a rectangular area of pixels sized to contain the target with minimal background.

18. The system of claim 1 wherein the current template or the current image may be rescaled prior to determining if a match exists.
